(19) United States
(12) Patent Application Publication
(10) Pub. No.: US 2026/0364848 A1
(43) Pub. Date: Nov. 19, 2026

(54) METHOD AND DEVICE FOR PRODUCING A CONCRETE SLAB MADE OF PRESTRESSED CONCRETE

(71) Applicant: HOLCIM TECHNOLOGY LTD, ZUG (CH)

(72) Inventors: Maximilian Leo Josef REINKE, HOLDERBANK (CH); Jörg SWITALA, HOLDERBANK (CH)

(21) Appl. No.: 19/121,016

(22) PCT Filed: Oct. 16, 2023
(86) PCT No.: PCT/IB2023/060405

§ 371 Date: Apr. 14, 2025

(30) Foreign Application Priority Data
Oct. 17, 2022 (EP) 22020492.9

(51) Int. Cl. B28B 23/04; B28B 17/00

(52) U.S. Cl. CPC B28B 23/04; B28B 17/0081

(57) ABSTRACT

A method for producing a concrete slab made of prestressed concrete, whose tensioning members include a plurality of rovings passing through the concrete slab, running parallel to the plane of the slab, includes creating formwork bounded at the bottom by a manufacturing table and whose side walls are traversed by prestressed rovings, and pouring concrete into the formwork and allowing the concrete to set. The pouring of concrete into the formwork includes dispensing the concrete through an adjustable outlet opening that extends substantially across the entire width of the formwork or through multiple outlet openings distributed across the width, of a movable pouring container, while the pouring container is moved along the length of the formwork. The fill level of the pouring container is monitored during dispensing and concrete is refilled from a reservoir container. The amount of refilled concrete is regulated during dispensing.

The invention relates to a method for manufacturing a concrete slab made of prestressed concrete, whose tensioning members comprise a plurality of rovings passing through the concrete slab and running parallel to the plane of the slab, in particular carbon fiber rovings, comprising the steps:
creating formwork that is bounded at the bottom by a manufacturing table and whose side walls are traversed by prestressed rovings, and
pouring concrete into the formwork and allowing the concrete to set.

Furthermore, the invention relates to an apparatus for manufacturing a concrete slab made of prestressed concrete.

In the manufacture of prestressed concrete, tensioning members, such as tensioning wires or tensioning strands, are connected to the concrete in a force-fitting manner so that relative displacement between the two materials practically does not occur. A direct bond between tensioning members and concrete can be established, as is often done in the production of precast concrete elements in precast plants, where tensioned wires or strands are embedded in the precast element. After the concrete has been poured and hardened, the prestressing is released. Through the bond between concrete and tensioning members as well as a wedging of the relaxed tensioning members, the tensioning force is applied to the precast element.

From WO 2014/040653A 1 , a precast concrete component has become known in which the reinforcement or the tensioning members are formed by a plurality of rovings, i.e., bundles, strands, or multi-filament yarns of parallel arranged filaments or continuous fibers. The rovings can comprise or consist of carbon or glass fibers. For the production of such fiber-reinforced concrete components, the rovings must be tensioned in several layers, overlapping in longitudinal and transverse directions. This process must be completed before beginning the production of the concrete components, and the tensioned rovings must pass through the formwork for the concrete component. After the formwork has been prepared, the area enclosed by the formwork is filled with concrete, whereby a height of fresh concrete that is as uniform as possible over the entire length and width of the concrete slab to be created must be ensured. The precise maintenance of a predefined height over the entire extension of the concrete slab is of particular importance in the case of concrete components reinforced with prestressed rovings because it must be ensured that the rovings have a defined position within the concrete slab with respect to a stress-neutral line. Otherwise, particularly with concrete slabs of small thickness and high prestressing forces, warping of the slab would occur.

The invention therefore aims to improve the production of concrete slabs made of prestressed concrete using rovings with regard to the introduction of fresh concrete into the formwork. In particular, an automated pouring process is to be realized with which a specified fresh concrete thickness can be achieved within tight tolerances. Furthermore, the introduction of fresh concrete should be carried out in such a way that the fragile rovings are not damaged.

To solve this problem, according to a first aspect, the invention consists essentially, in a method of the type mentioned at the outset, in that the pouring of concrete into the formwork comprises dispensing the concrete through an adjustable outlet opening that extends substantially across the entire width of the formwork or through multiple outlet openings distributed across the width, of a movable pouring container, while the pouring container is moved along the length of the formwork, wherein the fill level of the pouring container is monitored during dispensing and concrete is refilled from a reservoir container, and wherein the amount of refilled concrete is regulated such that the fill level in the pouring container is maintained between a minimum and a maximum value during dispensing.

By using two cascadingly arranged containers, the pouring container and the reservoir container, it is sufficient to maintain just enough fresh concrete in the pouring container for the pouring process, so that the weight load caused by the contained fresh concrete as well as any impact loads and associated deformations and sagging of the pouring container are minimized. This makes it possible to position the outlet opening(s) of the pouring container just slightly above the tensioned rovings and thus pour the fresh concrete onto the rovings from a low height, so that the transverse force load acting on the rovings and thus the risk of breakage are minimized. Preferably, it is provided that the outlet opening(s) of the pouring container is/are moved at a normal distance of 3-100 mm, in particular 3-15 mm, above the rovings. Optionally, the pouring container or its outlet opening(s) is/are continuously adjustable in height.

According to the invention, the refilling of concrete from the reservoir container into the pouring container is carried out in such a way that the fill level in the pouring container is constantly maintained between a minimum and a maximum value during concrete dispensing. This ensures, on the one hand, that only the currently required amount of fresh concrete is present in the pouring container at any time, and on the other hand, it limits the hydrostatic pressure exerted by the fresh concrete in the pouring container on the fresh concrete already present in the formwork. In particular, this is intended to prevent the hydrostatic pressure from causing the concrete to well up in the formwork and thus exceed the desired concrete thickness.

For maintaining the fill level between the minimum and a maximum value, a control loop is preferably provided in which the current fill level is the controlled variable and the refilled volume flow is the manipulated variable.

The minimum and maximum values of the fill level are specified in such a way that control can be carried out within relatively narrow limits, so that fluctuations in hydrostatic pressure are minimized. According to a preferred embodiment of the invention, it can be provided that the minimum value corresponds to 60-80% of the maximum value.

The refilling of concrete from the reservoir container into the pouring container is preferably continuous. This facilitates maintaining an as constant as possible fill level in the pouring container and avoids impact loads on the pouring container that could be caused by intermittent refilling.

Because, according to the invention, the dispensing of concrete is carried out via an adjustable outlet opening that extends substantially across the entire width of the formwork or via multiple outlet openings distributed across the width of a movable pouring container, uniform filling can be achieved over the entire width and length of the formwork.

The pouring container is preferably moved in an automated manner, i.e., by means of an automatic drive, in the longitudinal direction. The drive can be designed, for example, as an electric motor or hydraulic drive. The pouring container is moved during concrete dispensing especially at a constant speed in the longitudinal direction. The movement of the pouring container is carried out, for example, on wheels or in a sliding guide.

Within the scope of the present invention, the width and length preferably refer to two perpendicular directions of the formwork or the concrete slab to be produced, with the width preferably having a shorter extension than the length. The pouring container preferably has a cross-section that tapers funnel-shaped towards the outlet opening(s) and is particularly designed as a pouring funnel.

The one or more outlet opening(s) can have an adjustable outlet cross-section to regulate the volume flow through the outlet opening(s). This ensures that only as much concrete can flow from the funnel-shaped outlet opening(s) into the formwork as is required for the desired thickness of the concrete slab.

Furthermore, it has been found advantageous if the reservoir container is moved synchronously with the pouring container in the longitudinal direction of the formwork, while it is decoupled from the pouring container in the height direction. The decoupling here means that the reservoir container has a support independent of the pouring container, so that no vertical forces are exerted from the reservoir container onto the pouring container.

To ensure that the desired amount of concrete is present at each point along the width of the pouring container at all times, the reservoir container preferably extends substantially across the entire width of the formwork, whereby the concrete is refilled into the pouring container via a plurality of dispensing openings distributed across the width of the reservoir container, whereby the refilling is preferably carried out by means of at least one conveying device, preferably a plurality of conveying devices each assigned to a dispensing opening. The conveying device can be designed, for example, to achieve an even distribution of fresh concrete along the entire width of the reservoir container, so that a correspondingly uniform filling of the pouring container is achieved. The conveying device can preferably comprise a spiked roller extending over the entire width of the reservoir container.

Alternatively or additionally, several conveying devices distributed across the width of the reservoir container can be provided, which convey the fresh concrete via an associated dispensing opening into the underlying pouring container. Such conveying devices can be designed, for example, as sliders or screw conveyors.

In case the reservoir container has a plurality of dispensing openings through which the fresh concrete can be conveyed into the pouring container by means of a respective conveying device, a preferred embodiment provides that the monitoring of the fill level in successive width sections of the pouring container is carried out separately from each other with a fill level sensor arranged in the respective width section, whereby the fill level measurement values of each fill level sensor are used to control the refilling of concrete via that one of the dispensing openings that is located in the same width section as the respective fill level sensor. As a result, the fill level control in the pouring container is carried out in each width section separately from other width sections, so that any level differences along the width extension of the pouring container can be taken into account and compensated for.

To achieve a smooth surface of the fresh concrete mass at a defined height, it is preferably provided that a leveling device extending across the entire width of the concrete slab to be produced is dragged over the concrete poured into the formwork, following the pouring container, whereby the leveling device is preferably designed as a rigid or flexible leveling support, which is dragged behind the outlet opening of the pouring container, resting on the surface of the concrete. The leveling device is preferably attached to the pouring container, particularly on the rear side in the direction of travel. The leveling device prevents the fresh concrete from being pushed up by the hydrostatic pressure coming from the pouring container.

Preferably, a liquid, such as water, is applied across the width to the leveling support, which is allowed to run over the rear edge of the leveling support in the direction of travel onto the surface of the concrete. This forms a water layer on the fresh concrete surface, which ensures defined curing conditions for the concrete. By applying the liquid first to the leveling support rather than directly to the concrete, it is prevented that the applied liquid gets unevenly onto the concrete and affects the surface until final hardening. Preferably, a liquid layer of 1-2 cm thickness is applied.

According to a second aspect of the invention, an apparatus for manufacturing a concrete slab made of prestressed concrete is provided, comprising a pouring container for dispensing concrete into a formwork, wherein the pouring container has an adjustable outlet opening extending substantially across the entire width of the concrete slab to be produced or multiple outlet openings distributed across the width, and is movably arranged in a longitudinal direction perpendicular to the width, and further comprising a reservoir container for refilling concrete into the pouring container with at least one conveying device, wherein the pouring container has at least one fill level sensor for monitoring the fill level during the dispensing of concrete, whose measured values are fed to a control unit which cooperates with the at least one conveying device of the reservoir container to regulate the amount of refilled concrete such that the fill level in the pouring container is maintained between a minimum and a maximum value during dispensing.

Preferably, the minimum value corresponds to 60-80% of the maximum value.

Preferably, the control unit is designed for continuous controlled refilling of concrete into the pouring container. Advantageously, the reservoir container extends substantially across the entire width of the formwork and has a plurality of dispensing openings distributed across the width of the reservoir container, whereby preferably at least one conveying device, preferably a plurality of conveying devices each assigned to a dispensing opening, is/are arranged for dispensing the concrete into the pouring container.

For monitoring the fill level in successive width sections of the pouring container, a fill level sensor is preferably arranged in each width section, whereby the fill level measurements of the fill level sensors are fed to the control unit, which is designed to use the fill level measurement values of each fill level sensor to control the refilling of concrete via that one of the dispensing openings that is located in the same width section as the respective fill level sensor.

Preferably, it is provided that the outlet opening(s) of the pouring container is/are arranged at a normal distance of 3-100 mm, in particular 3-15 mm, above the rovings.

Preferably, a leveling device extending across the entire width of the concrete slab to be produced is arranged following the pouring container, wherein the leveling device is preferably designed as a rigid or flexible leveling support, which can be dragged behind the outlet opening of the pouring container, resting on the surface of the concrete.

Furthermore, liquid nozzles can be provided that are directed at the leveling support to apply the liquid across the width to the leveling support. The liquid can be used to carry out concrete after-treatment.

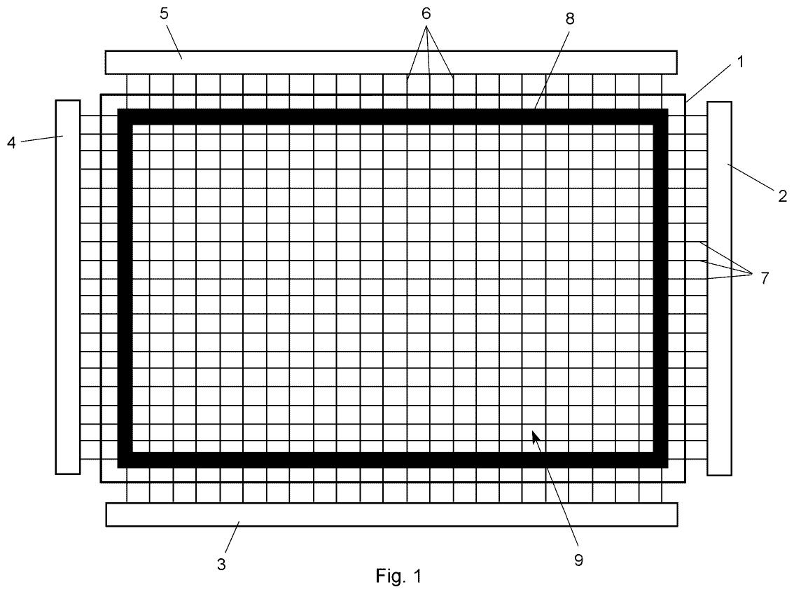

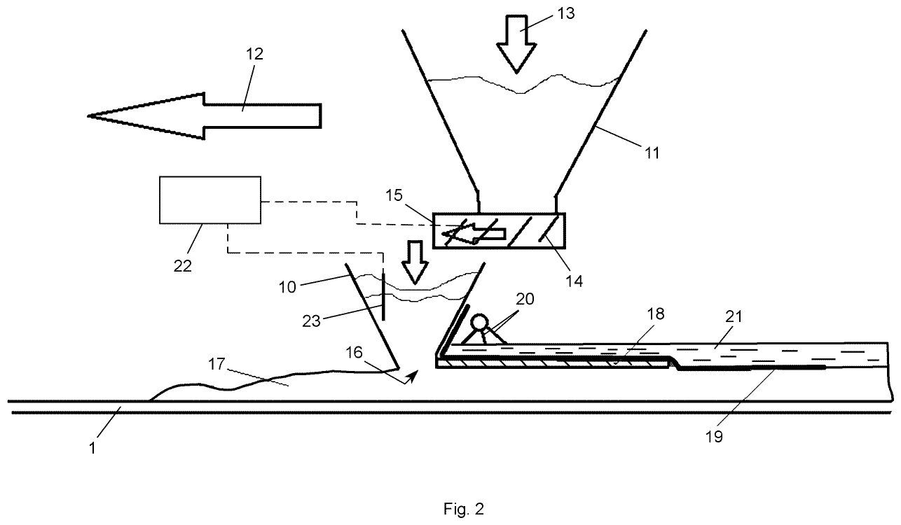

The invention is explained in more detail below based on schematically illustrated exemplary embodiments in the drawing. In this, FIG. 1 shows a top view of a manufacturing table including formwork for producing concrete slabs, and FIG. 2 shows a cross-section through a device for introducing fresh concrete into the formwork.

In FIG. 1, a manufacturing or formwork table 1 is shown, on the edges of which holding elements 2, 3, 4, and 5 are arranged, whereby between opposite holding elements 2 and 4 or 3 and 5, a plurality of carbon rovings 6, 7 are tensioned, whereby one group of carbon rovings 6 crosses another group of carbon rovings 7, and at least two layers of carbon rovings are arranged on top of each other. The carbon rovings thus span the manufacturing table 1 in two perpendicular directions.

The formwork table 1 forms the bottom of a formwork into which fresh concrete is poured for the production of a concrete slab made of prestressed concrete. After the formation of the edge formwork 8, liquid concrete is poured into the area 9 bounded by the edge formwork and allowed to set. After the concrete has hardened, the edge formwork is removed, and a concrete slab made of prestressed concrete remains.

FIG. 2 shows how the fresh concrete is introduced into the formwork. Directly above the area 9, a pouring container 10 extending across the entire width of the formwork, here a pouring funnel, is moved in the direction of arrow 12 in the longitudinal direction over the formwork, while fresh concrete from the pouring container 10 reaches the manufacturing table 1. Since the pouring container 10 holds only a relatively small volume of concrete in stock, a reservoir container 11 is moved synchronously with the pouring container 10 above the pouring container 10, from which concrete is refilled into the pouring container 10. The reservoir container 11 itself is again filled with concrete by pouring in fresh concrete as indicated by 13.

The reservoir container 11 has several dispensing openings 15 distributed across the width, through which concrete is conveyed into the pouring container 10 by means of a respective slider or screw conveyor 14. The pouring container 10, in turn, has a funnel-shaped outlet opening 16 that extends across the entire width of the pouring container 10 and through which the concrete 17 runs onto the manufacturing table 1. On the side of the pouring container 10 trailing in the direction of travel 12, a leveling support 18 is attached, which is pulled over the fresh concrete and smooths the concrete surface at a defined height. Optionally, a foil 19 can be arranged on the leveling support 18, which protrudes beyond the edge of the leveling support 18 on the rear side and is also pulled over the concrete surface. Additionally, a liquid is applied to the leveling support 18 across the width by means of nozzles 20, which is allowed to run over the rear edge of the leveling support 18, or if present, the foil 19, onto the surface of the concrete in the direction of travel 12.

For controlling the fill level in the pouring container 10, a fill level sensor 23 is provided, whose measurements are fed to a control unit 22, whereby the control unit generates control signals for the slider or screw conveyor 14 to maintain the fill level in the pouring container 10 within specified limits.

1. A method for producing a concrete slab made of prestressed concrete, whose tensioning members comprise a plurality of rovings, passing through the concrete slab, running parallel to a plane of the slab, comprising:
creating formwork that is bounded at a bottom by a manufacturing table and whose side walls are traversed by prestressed rovings, and
pouring concrete into the formwork and allowing the concrete to set, wherein the pouring of concrete into the formwork comprises dispensing the concrete through an adjustable outlet opening that extends substantially across an entire width of the formwork or through multiple outlet openings distributed across the width, of a movable pouring container, while the pouring container is moved along a length of the formwork, wherein a fill level of the pouring container is monitored during dispensing and concrete is refilled from a reservoir container, and wherein an amount of refilled concrete is regulated such that the fill level in the pouring container is maintained between a minimum and a maximum value during dispensing.

2. The method according to claim 1, wherein the minimum value corresponds to 60-80% of the maximum value.

3. The method according to claim 1, wherein the reservoir container is moved synchronously with the pouring container in a longitudinal direction of the formwork, while it is decoupled from the pouring container in a height direction.

4. The method according to claim 1, wherein the refilling of concrete into the pouring container is carried out continuously.

5. The method according to claim 1, wherein the reservoir container extends substantially across the entire width of the formwork and the concrete is refilled into the pouring container via a plurality of dispensing openings distributed across the width of the reservoir container.

6. The method according to claim 5, wherein the monitoring of the fill level in successive width sections of the pouring container is carried out separately from each other with a fill level sensor arranged in the respective width section, whereby the fill level measurement values of each fill level sensor are used to control the refilling of concrete via that one of the dispensing openings that is located in the same width section as the respective fill level sensor.

7. The method according to claim 1, wherein the outlet opening(s) of the pouring container is/are moved at a normal distance of 3-100 mm, above the rovings.

8. The method according to claim 1, wherein a leveling device extending across an entire width of the concrete slab to be produced is dragged over the concrete poured into the formwork, following the pouring container.

9. The method according to claim 8, wherein a liquid is applied across the width to the leveling support, which is allowed to run over a rear edge of the leveling support in a direction of travel onto the a surface of the concrete.

10. An apparatus for producing a concrete slab made of prestressed concrete, for carrying out the method according to claim 1, comprising a pouring container for dispensing concrete into a formwork, wherein the pouring container has an adjustable outlet opening extending substantially across an entire width of the concrete slab to be produced or multiple outlet openings distributed across the width, and is movably arranged in a longitudinal direction perpendicular to the width, and further comprising a reservoir container for refilling concrete into the pouring container with at least one conveying device wherein the pouring container has at least one fill level sensor for monitoring a fill level during the dispensing of concrete, whose measured values are fed to a control unit which cooperates with the at least one conveying device of the reservoir container to regulate the amount of refilled concrete such that the fill level in the pouring container is maintained between a minimum and a maximum value during dispensing.

11. The apparatus according to claim 10, wherein the minimum value corresponds to 60-80% of the maximum value.

12. The apparatus according to claim 10, wherein the reservoir container is moved synchronously with the pouring container in a longitudinal direction of the formwork, while it is decoupled from the pouring container in a height direction.

13. The apparatus according to claim 10, wherein the control unit is designed for continuous controlled refilling of concrete into the pouring container.

14. The apparatus according to claim 10, wherein the reservoir container extends substantially across an entire width of the formwork and has a plurality of dispensing openings distributed across a width of the reservoir container.

15. The apparatus according to claim 14, wherein for monitoring the fill level in successive width sections of the pouring container, a fill level sensor is arranged in each width section, whereby the fill level measurement values of the fill level sensors are fed to the control unit, which is designed to use the fill level measurement values of each fill level sensor to control the refilling of concrete via that one of the dispensing openings that is located in the same width section as the respective fill level sensor.

16. The apparatus according to claim 10, wherein the outlet opening(s) of the pouring container is/are arranged at a normal distance of 3-100 mm, above the rovings.

17. The apparatus according to claim 10, wherein a leveling device extending across the entire width of the concrete slab to be produced is arranged following the pouring container.

18. The apparatus according to claim 17, wherein liquid nozzles are provided that are directed at the leveling support to apply the liquid across the width to the leveling support.

19. The method according to claim 1, wherein the plurality of rovings are carbon fiber rovings.

20. The method according to claim 5, wherein the refilling is carried out by means of at least one conveying device.
